(19) United States
(12) Patent Application Publication
(10) Pub. No.: US 2026/0309982 A1
(43) Pub. Date: Oct. 8, 2026

(54) VEHICLE TRIM ELEMENT COMPRISING A MOVABLE IMAGE-PRODUCING UNIT

(71) Applicant: Faurecia Interieur Industrie, Nanterre (FR)

(72) Inventors: Patrick DOSSOU, Paris (FR); Gwenaël MONNIER, Noisy Le Roi (FR); Julien BEAUREGARD, Mesnil En Thelle (FR); Jérémy FLOCH, Allonne (FR); Erwan SAGOT-DUTERTRE, Meru (FR); Thibault LE MESNIL, CERGY (FR)

(21) Appl. No.: 19/639,045

(22) Filed: Apr. 3, 2026

(30) Foreign Application Priority Data
Apr. 4, 2025 (FR) FR 25 03571

(51) Int. Cl. G02B 27/01; B60Q 3/50; B60Q 3/62; B60Q 3/70

(52) U.S. Cl. CPC G02B 27/0149; B60Q 3/50; B60Q 3/62; B60Q 3/70; G02B 27/0101; G02B 2027/0154

(57) ABSTRACT

Vehicle trim element comprising a movable image-producing unit The trim element (1) comprises: a body (2) comprising at least one first part (8); at least one semi-reflective blade (4), at least one image-producing unit (6) extending facing an outer face (16) of the semi-reflective blade (4). The image-producing unit (6) is movable between a reflection position, in which the light beams emitted by the image-producing unit (6) are partly reflected on the outer face (16) of the semi-reflective blade (4), and at least one other position, in which the semi-reflective blade (4) does not produce an image by reflection of light beams emitted by the image-producing unit (6). Figure for the abstract: 1

### DESCRIPTION

The present invention relates to a vehicle trim element of the type comprising:
a body comprising at least one first part;
at least one semi-reflective blade extending facing an outer surface of the first part of the body between an inner face, facing the outer surface of the first part, and an outer face, opposite the inner face,
at least one image-producing unit extending facing the outer face of the semi-reflective blade and arranged to emit light beams when the image-producing unit is activated.

It is known to provide an image-producing unit in a trim element, such as a dashboard, a central console or the like, in order to display images on an outer surface of the trim element.

When active, the image-producing unit displays, for example, various types of information relating to the operation of the vehicle.

Such an image-producing unit is, for example, arranged on part of the trim element extending facing an outer surface of a coating element. The image-producing unit is then arranged to emit images toward the outer surface of the coating element, the images then being displayed on the outer surface of the coating element by reflection of the images from the image-producing unit.

The outer surface of the coating element is generally at least partly reflective, so as to reflect images projected by the image-producing unit toward a user located in the passenger compartment of the vehicle.

Such an arrangement is advantageous in that it allows the trim element to have a uniform appearance in the display area of the images of the image-producing unit and around it, especially when the image-producing unit is not activated, this appearance being imparted by the outer surface of the coating element.

In order to improve the visual quality of the trim element when the image-producing unit is activated, it has been proposed that the images are projected onto a semi-reflective blade forming part of the outer surface of the trim element, and an inner face of which extends facing a decorative element. Such a semi-reflective blade creates a virtual image in a plane between the decorative element and the semi-reflective blade, and appears to float beyond the outer surface for the user. The floating image creates a surprising effect for the user.

However, although the production of floating images is suitable for the display of simple information or animations, the use of such floating images is not satisfactory for the display of certain content, in particular audiovisual content intended to be displayed "flat" on a conventional display surface, such as the display surface of a screen, and/or content that requires more contrast or brightness. Additionally, when the image-producing unit is used, it increases the size of the trim element, which can be a nuisance, particularly when the image-producing unit is not in use.

One of the aims of the invention is to provide a trim element that improves the visual experience of a vehicle user, especially by offering a modularity in the nature or quality of the visible images coming from an image-producing unit.

For this purpose, the invention relates to a trim element of the aforementioned type, wherein the image-producing unit is movable with respect to the first part of the body and the semi-reflective blade between a reflection position, wherein the light beams emitted by the image-producing unit are partly reflected on the outer face of the semi-reflective blade so that the reflected image is visible from outside the trim element, and at least one other position, different from the reflection position, wherein the semi-reflective blade does not produce an image by reflection of light beams emitted by the image-producing unit.

By making the image-producing unit movable with respect to the semi-reflective blade, it is possible to alter the quality of the images produced by the image-producing unit, these being, for example, floating images in the reflection position, whereas in another position, wherein the semi-reflective blade does not produce an image by reflection of light beams from the image-producing unit, the image-producing unit can be made directly visible from the passenger compartment of the vehicle receiving the trim element so that the images are displayed flat on the image-producing unit. It is also possible to reduce the size of the trim element by providing an alternative position wherein the image-producing unit is, for example, folded back against the semi-reflective blade, particularly when the image-producing unit is not in use. This alternative position then extends the field of vision of vehicle occupants beyond the trim element, particularly when the latter is installed behind a windshield in the case of a dashboard, for example.

The trim element according to the invention may comprise one or more of the following features, taken alone or according to any technically conceivable combination:

the image-producing unit is brought close to the outer face of the semi-reflective blade as it is moved between the reflection position and the other position, the other position being a close position, the image-producing unit masking at least part of the outer face of the semi-reflective blade from the outside of the trim element in said close position, the image-producing unit being switched off in this position;

the image-producing unit extends substantially parallel to the outer face of the semi-reflective blade in the close position;

the image-producing unit is moved away from the outer face of the semi-reflective blade when it is moved between the reflection position and the other position, the other position being a spaced position, the light beams emitted by the image-producing unit being directed toward the outside of the trim element without being reflected on the outer face of the semi-reflective blade in said spaced position;

the image-producing unit is movable between the reflection position and a plurality of other positions, the image-producing unit being moved toward or away from the outer face of the semi-reflective blade when it is moved between the reflection position and one of the other positions;

the image-producing unit is rotatable between the reflection position and the other position, the angle formed between the image-producing unit and the outer face of the semi-reflective blade increasing or decreasing as the image-producing unit is moved from the reflection position to the other position.

the body comprises a second part extending facing the first part, the image-producing unit being mounted in said second part of the body.

the second part of the body is movable with the image-producing unit with respect to the first part of the body between the reflection position and the other position.

the image-producing unit is movable with respect to the second part of the body between the reflection position and the other position;

the image-producing unit and the semi-reflective blade are arranged to generate a virtual image extending between the inner face of the semi-reflective blade and the outer surface of the first part of the body in the reflection position of the image-producing unit.

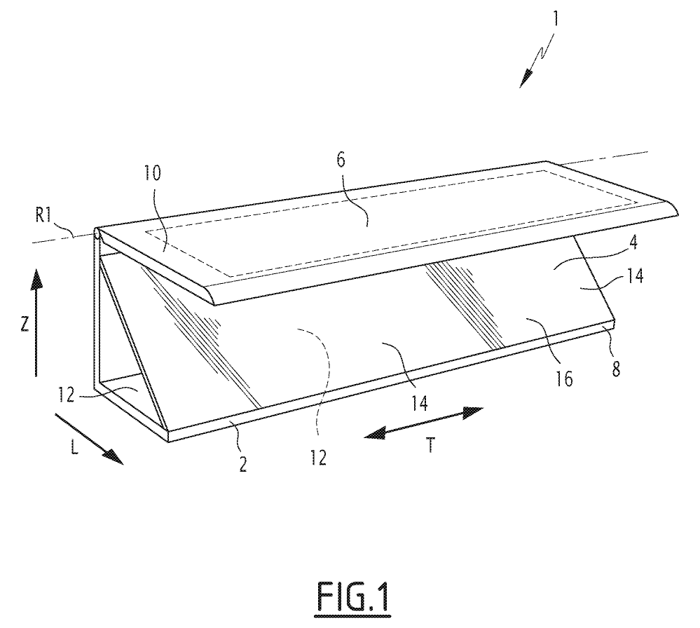

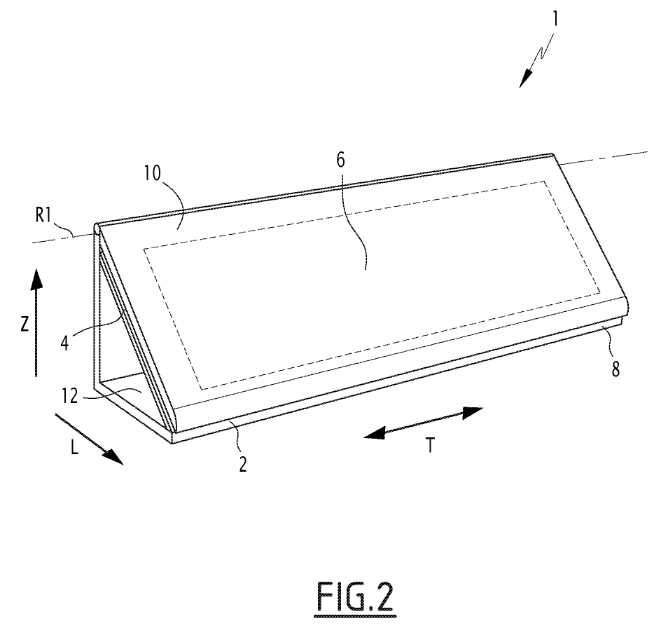

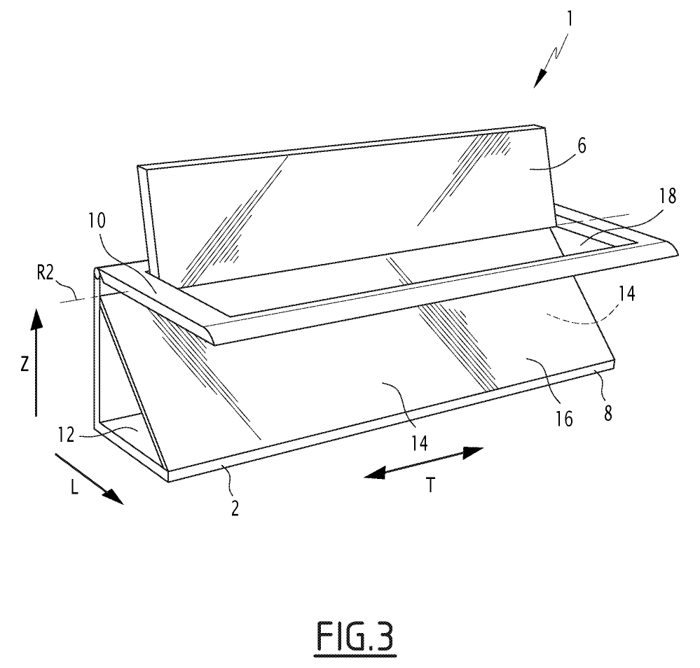

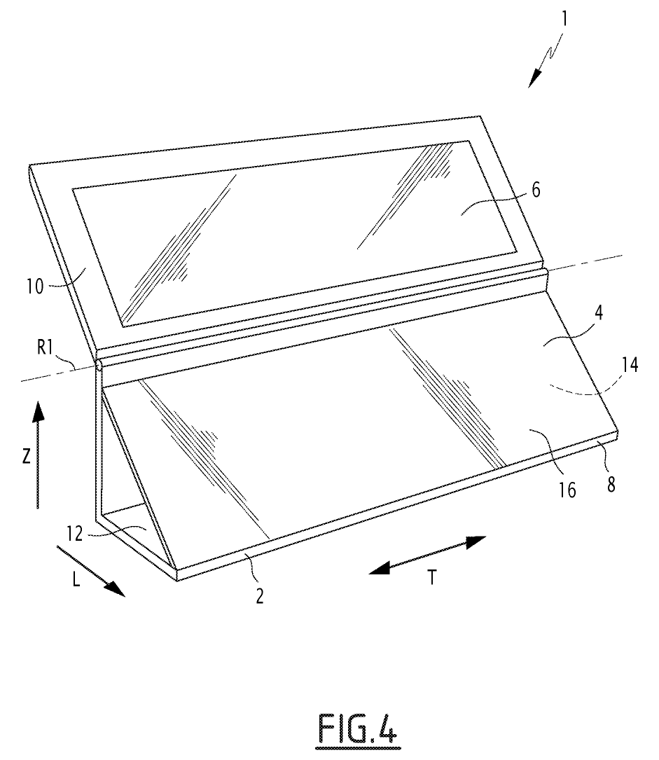

Other aspects and advantages of the invention will appear more clearly on reading the following description, given solely by way of non-limiting example, and made with reference to the drawings, wherein:

[FIG. 1] - FIG. 1 is a schematic perspective view showing a trim element according to the invention, with the image-producing unit in a reflection position;

[FIG. 2] - FIG. 2 is a schematic perspective view of the trim element of FIG. 1, with the image-producing unit in another position, corresponding to a close position,

[FIG. 3] - FIG. 3 is a schematic perspective view of the trim element of FIG. 1, with the image-producing unit in a different position, corresponding to a spaced position, and

[FIG. 4] - FIG. 4 is a schematic perspective view of the trim element of FIG. 1, with the image-producing unit in yet another different position, corresponding to another spaced position.

Referring to FIG. 1, a vehicle trim element 1 comprising a body 2, at least one semi-reflective blade 4 and at least one image-producing unit 6 is described. Such a trim element forms, for example, a vehicle dashboard, a central console, a door panel or other.

The body 2 is arranged to impart its general shape and its mechanical characteristics to the trim element 1. The body 2 comprises at least a first part 8 that extends in a visible part of the vehicle passenger compartment by at least one occupant of the vehicle. In the example shown in the figures, the trim element 1 is a dashboard and the first part 8 corresponds to a lower part of the body 2 which extends facing the front occupants of a vehicle and serves as a support for several functional elements, such as an instrumentation panel, a glovebox, an audio and/or air conditioning system, etc.

According to the embodiment shown in the figures, the body 2 further comprises a second part 10 extending facing at least part of the first part 8 of the body 2. The second part 10 is moved away from the first part 8 in an elevation direction Z, corresponding, for example, in the case of a dashboard, to the height of the vehicle. Thus, when the trim element 1 is a dashboard, the second part 10 is cantilevered out from the first part 8 in a longitudinal direction L, as shown in the figures, like a protective cover for the first part 8. The longitudinal direction L is substantially perpendicular to the elevation direction Z. In the case of a dashboard, the longitudinal direction L corresponds, for example, to the front-to-rear direction of the vehicle. According to one embodiment, the second part 10 is itself made up of several sub-parts, as will be described in greater detail later.

The first part 8 of the body comprises an outer surface 12 forming a portion of the first part 8 of the body visible from the vehicle passenger compartment. According to one embodiment, the first part 8 of the body comprises a coating element forming the outer surface 12 of the first part 8 of the body. According to the embodiment shown in the figures, at least the outer surface 12 of the first part 8 of the body 2 has an L-shaped cross-section in a plane comprising the longitudinal direction L and the elevation direction Z.

“Inner” and “behind” refer to what is turned toward the element of the passenger compartment of the vehicle on which the trim element is installed, and “outer” and “in front of” refer to what is turned toward the passenger compartment of the vehicle.

The semi-reflective blade 4 extends between an inner face 14 facing the outer surface 12 of the first part 8 of the body, forming at least part of a visible surface of the trim element 1, and an outer face 16, opposite the inner face 14 and forming at least part of a visible surface of the trim element 1 at least in a reflective position of the image-producing unit 6, as shown in FIG. 1 and as will be described in more detail later. A visible surface refers to a surface which is visible by the occupants of the vehicle when the trim element 1 is installed in the passenger compartment of a vehicle. The semi-reflective blade 4 is, for example, attached at one, or at each, of its ends to the first part 8 and/or to the second part 10 of the body 2.

At least part of the outer face 16 of the semi-reflective blade 4 defines at least one display area corresponding to the area over which the image-producing unit 6 emits light beams in the reflection position, as will be described later.

As will be described in more detail later, the image-producing unit 6 is movable between the aforementioned reflection position shown in FIG. 1 and at least one other position, preferably a plurality of other positions as shown in FIG. 2 to 4.

The display of an image by means of the image-producing unit 6, in the reflection position, and the semi-reflective blade 4 will now be described.

In the reflection position, shown in FIG. 1, the image-producing unit 6 extends facing the outer face 16 of the semi-reflective blade 4 and is arranged to emit light beams toward the display area when the image-producing unit 6 is activated. The light beams emitted by the image-producing unit 6 are arranged to represent, for example, a particular pattern, such as an image, or an icon representative of certain functions of the vehicle, such as adjustment of the temperature inside the passenger compartment, management of multimedia, or the like. The image-producing unit 6 can, for example, further broadcast audiovisual content, such as a video, film or the like.

The image-producing unit 6, for example, is installed in the second part 10 of the body 2 so as to face the outer face 16 of the semi-reflective blade 4 in the reflection position. In this position, the image-producing unit 6 is, for example, essentially invisible directly from the outside of the trim element 1. In other words, in the reflection position, a user seated facing the trim element 1 does not directly see the light emitted by the image-producing unit 6, but only a reflection of it on the outer face 16 of the semi-reflective blade 4, as will now be described.

In the case of an image-producing unit 6 installed in the second part 10 of the body 2, which is spaced apart from the first part 8 in the elevation direction Z, the light beams emitted by the image-producing unit 6 are directed substantially in the elevation direction Z toward the outer surface 16 of the first part 8 of the body 2.

As previously indicated, the semi-reflective blade 4 is configured to at least partly reflect the light beams received from the image-producing unit 6 onto the display area. “Configured to reflect” is understood to mean that a light beam with a wavelength of between 400 nm and 750 nm is partly reflected by the semi-reflective blade 4 when it strikes the outer face 16 and/or the inner face 14 of the semi-reflective blade 4. For example, the semi-reflective blade has a reflectivity of between 20% and 30%. In other words, between 20% and 30% of the electromagnetic energy of an incident light beam with a wavelength between 400 nm and 750 nm is reflected by the semi-reflective blade 4, and the remaining percentage of electromagnetic energy is transmitted by the semi-reflective blade 4.

The semi-reflective blade 4 is at least partially transparent. Thus, a user located in the passenger compartment of the vehicle can see through the semi-reflective blade 4 when the image-producing unit 6 is inactive but also when the image-producing unit 6 is active.

When a light beam emitted by the first image-producing unit 6 in the reflection position strikes the semi-reflective blade 4, a first part of the light beam is reflected toward the outside of the trim element 1, that is to say toward the user's eyes, and a second part is refracted toward the inner face 14 of the semi-reflective blade in a space extending between the inner face 14 of the semi-reflective blade 4 and the outer surface 12 of the first part 8 of the body 2.

To direct the reflected light beams toward the user, the semi-reflective blade 4 is tilted with respect to the elevation direction Z. Thus, the inner face 14 and outer face 16 of the semi-reflective blade 4 form an angle of between 30° and 60°, for example substantially equal to 45°, with the elevation direction Z.

The light beams are reflected toward the user, creating a virtual image on the inside of the semi-reflective blade 4. In other words, a user observing the outer face 16 of the semi-reflective blade 4 has the impression that the image observed extends behind or beyond the semi-reflective blade 4, more specifically that it extends between the inner face 16 of the semi-reflective blade 4 and the outer surface 12 of the first part 8 of the body 2 along the longitudinal direction L. The semi-reflective blade 4 is also tilted with respect to the longitudinal direction L and forms an angle of between 30° and 60°, for example substantially equal to 45°. Due to the orientation of the semi-reflective blade 4, the virtual image visible to the user extends, for example, in a plane substantially perpendicular to the longitudinal direction L.

The semi-reflective blade 4 is, for example, made of plastic material, for example acrylic polymethyl methacrylate, and/or is made of glass. The semi-reflective blade 4 has for example a thickness, measured between the inner face 14 and the outer face 16, of between 4 mm and 5 mm when the semi-reflective blade 4 is made of plastic material, and of at least 2 mm when the semi-reflective blade 4 is made of glass. At least the outer face 16, preferably also the inner face 14, of the semi-reflective blade 4 is a flat surface. “Flat” is understood to mean that the outer face 16, and preferably also the inner face 14, is substantially flat with a maximum deviation of 0.5 mm per 100 mm.

In the other position, the semi-reflective blade 4 does not produce an image by reflecting the light beams emitted by the image-producing unit 6. In other words, the image-producing unit 6 is moved with respect to the semi-reflective blade so that the reflection by the semi-reflective blade 4 of light beams emitted by the image-producing unit 6 toward the outside of the trim element 1 is prevented or stopped, as will be described in more detail later. For this purpose, in the other position, the image-producing unit 6 is brought closer to the semi-reflective blade 4 than in the reflection position, as shown in FIG. 2, or is moved away from it, as shown in FIG. 3 and 4. To this end, the image-producing unit 6, for example, can be rotated between the reflection position and the other position.

According to one embodiment, the second part 10 of the body 2 is rotatable with the image-producing unit 6 between the reflection position and the other position, as shown in FIG. 2 and 4. In this case, the second part 10 of the body 2 is, for example, articulated to the first part 8 about an axis of rotation R1 extending in a transverse direction T, substantially perpendicular to the longitudinal direction L and to the elevation direction Z. In this way, the second part 10 can be moved toward or away from the first part 8, causing the image-producing unit 6, carried by the second part 10, to move between the reflection position and another position.

Alternatively or additionally, when the second part 10 is made up of several sub-parts, for example two sub-parts, the image-producing unit 6 is mounted on one of the sub-parts and this sub-part is rotationally movable with the image-producing unit 6 with respect to the other sub-part between the reflection position and the other position. In this case, the sub-part not carrying the image-producing unit 6 is, for example, fixed with respect to the first part 8, and the other sub-part is rotatable about the axis of rotation R1 with respect to the fixed sub-part. In this way, the axis of rotation R1 can extend at any point along the second part 10 in the longitudinal direction L to allow rotation of the image-producing unit 6.

In FIG. 1, 2 and 4, the axis of rotation R1 has been shown at the transition between the first part 8 and the second part 10, but it is understood that this axis of rotation could be shifted toward the opposite end of the second part 10 along the longitudinal direction L to modify the kinematics of rotation of the image-producing unit 6 with respect to the first part 8 and/or with respect to another sub-part of the second part 10, as will be described in more detail later. Alternatively or additionally, the image-producing unit 6 can be rotated with respect to the second part 10 of the body 2 between the reflection position and the other position, as shown in FIG. 3. In this case, the image-producing unit 6 is articulated to the second part 10 about an axis of rotation R2 extending in the transverse direction T. The image-producing unit 6 can thus be moved with respect to the second part 10, in particular between a position wherein the image-producing unit 6 extends into a housing 18 of the second part 10 in the reflection position, and a position, shown in FIG. 3, wherein the image-producing unit 6 extends out of the housing 18 projecting from the second part 10 substantially in the elevation direction Z or a direction slightly inclined to the elevation direction Z. The housing 18 is provided, for example, with a window extending facing the display area of the outer face 16 of the semi-reflective blade 4, so that the light beams emitted by the image-producing unit 6 reach the display area when the image-producing unit 6 extends into the housing 18. As with the rotation axis R1, the rotation axis R2 can extend at any point along the image-producing unit 6 in the longitudinal direction L to allow rotation of the image-producing unit 6 in order to alter the rotation kinematics of the image-producing unit 6 with respect to the second part 10, as will be described in greater detail later.

When the image-producing unit 6 is brought closer to the semi-reflective blade 4 in the other position, this other position is referred to as the "close position", and the angle formed between the image-producing unit 6 and the outer face 16 of the semi-reflective blade 4 decreases as the image-producing unit 6 is moved from the reflection position to the close position.

Thus, in the close position, the image-producing unit 6 masks at least part of the outer face 16 of the semi-reflective blade 4 so that this part is not visible from outside the trim element 1. The close position is useful, for example, when the image-producing unit 6 is not activated, or switched off, and does not emit light. In this case, it is not necessary to maintain visibility of the outer face 16 of the semi-reflective blade 4 from outside the trim element, which therefore does not emit an image by reflection of light beams emitted by the image-producing unit 6, and the image-producing unit 6 can be folded back toward the semi-reflective blade 4 to reduce the footprint of the trim element 1, particularly in the elevation direction Z. This embodiment is particularly advantageous when the whole of the second part 10 carrying the image-producing unit 6 is movable into the close position in order to mask the whole of the semi-reflective blade 4 and the outer surface 12 of the first part 8, as shown in FIG. 2. The second part 10 then forms a cover for the trim element, which can be placed in the close position to clear the field of vision of vehicle passengers when the image-producing unit 6 is not in use. Thus, when the trim element 1 is a dashboard, for example, the close position clears the lower part of the vehicle windshield and improves the field of vision therethrough.

The close position is, for example, such that the image-producing unit 6, and advantageously the entire inner surface of the second part 10, extends substantially parallel to the outer face 16 of the semi-reflective blade 4. According to one embodiment, the inner surface of the second part 10 extends against the outer face 16 of the semi-reflective blade in the close position.

When the image-producing unit 6 is brought away from the semi-reflective blade 4 in the other position, this other position is referred to as the "spaced position", and the angle formed between the image-producing unit 6 and the outer face 16 of the semi-reflective blade 4 increases as the image-producing unit 6 is moved from the reflection position to the close position.

In the spaced position, the image-producing unit 6 emits light beams directly toward the vehicle passenger compartment. In other words, in the spaced position, the light beams emitted by the image-producing unit 6 are not reflected on the outer face 16 of the semi-reflective blade 4 before being visible to vehicle occupants. Thus, in the spaced position, the images produced by the image-producing unit 6 are directly visible thereupon, so that the image-producing unit 6 can then be used like a traditional screen. Such a position is particularly advantageous for displaying audiovisual content and/or complex, detailed images, as the images are displayed flat on the image-producing unit 6 and feature improved contrast compared with a floating image obtained in the reflection position.

In the spaced position, the angle between the image-producing unit 6 and the outer face 16 of the semi-reflective blade 4 can be adjusted in order to set the orientation of the image-producing unit 6 and adapt it, for example, to the position and/or morphology of the person or persons observing the image-producing unit 6 in the spaced position.

Alternatively, and as described above, the axis of rotation R1 of a sub-part of the second part 10 and/or the axis of rotation R2 of the image-producing unit 6 can be positioned along the longitudinal direction L so that the other position makes the image-producing unit 6 directly visible from the vehicle passenger compartment without the image-producing unit 6 moving away from the semi-reflective blade 4. In this way, the image-producing unit can tilt toward the semi-reflective blade 4 so as to interpose itself between the semi-reflective blade 4 and the vehicle passenger compartment while emitting light beams toward the vehicle passenger compartment. In other words, in this other position, images are visible in the same area as in the reflection position, but they are displayed directly on the image-producing unit 6 rather than being reflected by the semi-reflective blade 4. Such rotational kinematics can be achieved by placing the axis of rotation R1 of a sub-part of the second part 10 or the axis of rotation R2 of the image-producing unit 6 at an edge of the image-producing unit that, in the longitudinal direction L, is opposite the edge of the image-producing unit 6 closest to the junction between the first part 8 and the second part 10.

Advantageously, the image-producing unit 6 is movable, with the second part 10 and/or independently thereof, between the reflection position and a plurality of other positions, corresponding to close positions and/or spaced positions. It should be noted that the light beams emitted by the image-producing unit 6 produce a floating virtual image visible from the vehicle passenger compartment only in the reflection position, all other positions corresponding to positions wherein the image-producing unit 6 masks at least part of the outer face 16 of the semi-reflective blade 4 or wherein the light beams emitted by the image-producing unit 6 are not reflected on the outer face 16 of the semi-reflective blade 4.

According to one embodiment, the trim element 1 comprises several image-producing units 6 adjacent to one another or spaced apart along the transverse direction T. In this case, the second part 10 of the body 2 is movable with respect to the first part 8, for example, to move the set of image-producing unit 6 together between the reflection position and the other position(s). Alternatively or additionally, each image-producing unit 6 is movable with respect to the second part 10 so as to move the image-producing units 6 between the reflection position and the other position(s) independently of one another.

According to this embodiment, the trim element 1 can comprise a single semi-reflective blade 4 for a plurality of image-producing units 6, or a plurality of semi-reflective blades, each semi-reflective blade 4 extending facing an image-producing unit 6.

The trim element 1 described above offers a high degree of modularity in image display. Additionally, the trim element 1 retains a satisfactory appearance and a reduced footprint when the image-producing unit is deactivated by placing the second part 10 of the body 2 in the close position.

1. A vehicle trim element comprising:
a body comprising at least one first part;
at least one semi-reflective blade extending facing an outer surface of the first part of the body between an inner face, facing the outer surface of the first part, and an outer face, opposite the inner face,
at least one image-producing unit extending facing the outer face of the semi-reflective blade and arranged to emit light beams when the image-producing unit is activated,
wherein the image-producing unit is movable with respect to the first part of the body and the semi-reflective blade between a reflection position, in which the light beams emitted by the image-producing unit are partly reflected on the outer face of the semi-reflective blade so that the reflected image is visible from outside the trim element, and at least one other position, different from the reflection position, in which the semi-reflective blade does not produce an image by reflection of light beams emitted by the image-producing unit.

2. The trim element according to claim 1, wherein the image-producing unit is brought close to the outer face of the semi-reflective blade as it is moved between the reflection position and the other position, the other position being a close position, the image-producing unit masking at least part of the outer face of the semi-reflective blade from the outside of the trim element in said close position, the image-producing unit being switched off in this position.

3. The trim element according to claim 2, wherein the image-producing unit extends substantially parallel to the outer face of the semi-reflective blade in the close position.

4. The trim element according to claim 1, wherein the image-producing unit is moved away from the outer face of the semi-reflective blade when it is moved between the reflection position and the other position, the other position being a spaced position, the light beams emitted by the image-producing unit being directed toward the outside of the trim element without being reflected on the outer face of the semi-reflective blade in said spaced position.

5. The trim element according to claim 1, wherein the image-producing unit is movable between the reflection position and a plurality of other positions, the image-producing unit being moved toward or away from the outer face of the semi-reflective blade when it is moved between the reflection position and one of the other positions.

6. The trim element according to claim 1, wherein the image-producing unit is rotatable between the reflection position and the other position, the angle formed between the image-producing unit and the outer face of the semi-reflective blade increasing or decreasing as the image-producing unit is moved from the reflection position to the other position.

7. The trim element according to claim 1, wherein the body comprises a second part extending facing the first part, the image-producing unit being mounted in said second part of the body.

8. The trim element according to claim 7, wherein the second part of the body is movable with the image-producing unit with respect to the first part of the body between the reflection position and the other position.

9. The trim element according to claim 7, wherein the image-producing unit is movable with respect to the second part of the body between the reflection position and the other position.

10. The trim element according to claim 1, wherein the image-producing unit and the semi-reflective blade are arranged to generate a virtual image extending between the inner face of the semi-reflective blade and the outer surface of the first part of the body in the reflection position of the image-producing unit.
